(19) United States
(12) Patent Application Publication
(10) Pub. No.: US 2025/0124908 A1
(43) Pub. Date: Apr. 17, 2025

(54) SYSTEM, APPARATUS, AND METHOD FOR SOUND CONTROL

(71) Applicant: Artem Fedorenko, Vernon Hills, IL (US)

(72) Inventor: Artem Fedorenko, Vernon Hills, IL (US)

(21) Appl. No.: 18/485,671

(22) Filed: Oct. 12, 2023

(51) Int. Cl. G10K 11/168; B32B 7/12; B32B 15/06; B32B 25/04; B32B 25/08; B32B 25/12; B32B 25/18

(52) U.S. Cl. CPC G10K 11/168; B32B 7/12; B32B 15/06; B32B 25/042; B32B 25/045; B32B 25/08; B32B 25/12; B32B 25/18; B32B 2250/03; B32B 2307/102; B32B 2307/302; B32B 2307/7246; B32B 2307/7376

(57) ABSTRACT

A sound control membrane is disclosed. The sound control membrane has a viscoelastic layer, a protective layer attached to the viscoelastic layer, and a thermal isolating layer attached to the viscoelastic layer. The viscoelastic layer is disposed between the protective layer and the thermal isolating layer. The sound control membrane also has an attachment layer attached to the thermal isolating layer.

### TECHNICAL FIELD

The present disclosure generally relates to a system, apparatus, and method for handling sound, and more particularly to a system, apparatus, and method for sound control.

### BACKGROUND

Various techniques are used for noise control in applications such as buildings and other structures. For example, material is often applied to structural components such as walls, pipes, and other elements through which it is not desirable for sound to pass.

One conventional technique for noise control involves attaching material such as bitumen or lead to structural components. However, such material may be unwieldy, toxic, and/or may cause an unpleasant smell when subjected to temperature increases. Other conventional materials are often inflexible and difficult to apply to structural components. Further, many conventional techniques include volatile substances or are combustible. Also, conventional techniques may not perform well in areas of high humidity and/or temperature variation.

The exemplary disclosed system, apparatus, and method of the present disclosure are directed to overcoming one or more of the shortcomings set forth above and/or other deficiencies in existing technology.

### SUMMARY OF THE DISCLOSURE

In one exemplary aspect, the present disclosure is directed to a sound control membrane. The sound control membrane includes a viscoelastic layer, a protective layer attached to the viscoelastic layer, and a thermal isolating layer attached to the viscoelastic layer. The viscoelastic layer is disposed between the protective layer and the thermal isolating layer.

In another aspect, the present disclosure is directed to a sound control method. The sound control method includes providing a sound control membrane including a viscoelastic layer, a protective layer attached to the viscoelastic layer, a thermal isolating layer attached to the viscoelastic layer, and an attachment layer attached to the thermal isolating layer. The viscoelastic layer is disposed between the protective layer and the thermal isolating layer. The sound control method also includes attaching the sound control membrane to an element by attaching the attachment layer to a surface of the element.

### BRIEF DESCRIPTION OF THE DRAWINGS

FIG. 1 is a perspective view of an exemplary embodiment of the present invention;

FIG. 2 is a sectional view of an exemplary embodiment of the present invention;

FIG. 3 is another sectional view of an exemplary embodiment of the present invention;

FIG. 4 is a side view of an exemplary embodiment of the present invention;

FIG. 5A is a sectional view of an exemplary manufacturing process of an exemplary embodiment of the present invention;

FIG. 5B is another sectional view of an exemplary manufacturing process of an exemplary embodiment of the present invention;

FIG. 5C is another sectional view of an exemplary manufacturing process of an exemplary embodiment of the present invention;

FIG. 5D is another sectional view of an exemplary manufacturing process of an exemplary embodiment of the present invention;

FIG. 5E is another sectional view of an exemplary manufacturing process of an exemplary embodiment of the present invention;

FIG. 6A is a perspective view of an exemplary method of using an exemplary embodiment of the present invention;

FIG. 6B is another perspective view of an exemplary method of using an exemplary embodiment of the present invention;

FIG. 6C is another perspective view of an exemplary method of using an exemplary embodiment of the present invention;

FIG. 6D is another perspective view of an exemplary method of using an exemplary embodiment of the present invention; and

FIG. 7 illustrates an exemplary process of making at least some exemplary embodiments of the present disclosure.

### DETAILED DESCRIPTION AND INDUSTRIAL APPLICABILITY

The exemplary disclosed system, apparatus, and method may include an apparatus that may be a membrane. The exemplary disclosed membrane may be a sound control membrane (e.g., a soundproofing membrane for noise control). The exemplary disclosed membrane may be used for sound control of any suitable element or location such as, for example, a structure, a vehicle, and/or any other suitable element or location. For example, the exemplary disclosed membrane may be applied to any suitable element or location such as, for example, a building (e.g., exterior or interior building component such as a wall, door, floor, ceiling, air duct, pipes, or other component), sewer pipe and/or risers, sheet metal and/or sheet metal members or structures, a tunnel, a bridge, a portion of a road, an aircraft (e.g., rotary or fixed wing aircraft), a surface or submersible maritime vessel, and/or any other suitable element, object, or structure through which sound may be transferred.

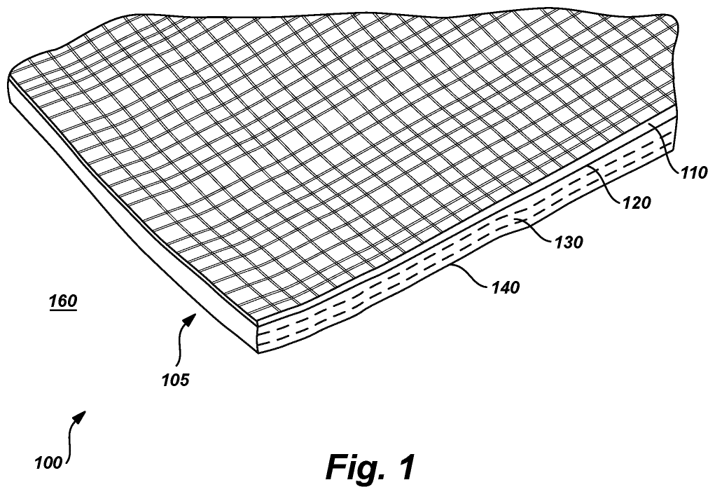

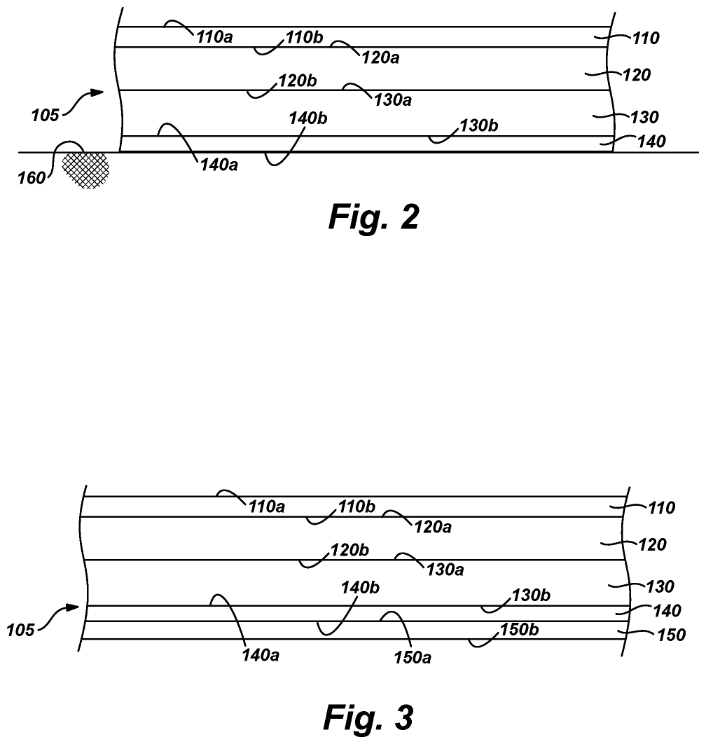

FIGS. 1-3 illustrate an exemplary disclosed sound control system 100 that may include a membrane 105. Membrane 105 may be a composite membrane. Membrane 105 may include a protective layer 110, a viscoelastic layer 120, an isolating layer 130, and an attachment layer 140. Protective layer 110, viscoelastic layer 120, isolating layer 130, and attachment layer 140 may be formed together to form membrane 105. In at least some exemplary embodiments, membrane 105 may include protective layer 110, viscoelastic layer 120, and isolating layer 130, without attachment layer 140.

A first surface 110a of protective layer 110 may form an exterior surface of membrane 105 that faces away from a surface 160 of an element to which membrane 105 may be attached for sound control. A second surface 110b of protective layer 110 may be attached to a first surface 120a of viscoelastic layer 120. A second surface 120b of viscoelastic layer 120 may be attached to a first surface 130a of isolating layer 130. A second surface 130b of isolating layer 130 may be attached to a first surface 140a of attachment layer 140. A second surface 140b of attachment layer 140 may be attached to surface 160 of an element to which membrane 105 may be attached for sound control. Surfaces 110b and 120a, 120b and 130a, and 130b and 140a may be attached via any suitable technique such as, for example, adhesive, heat pressing, mechanical fasteners, stitching, and/or any other suitable attachment technique. In at least some exemplary embodiments, viscoelastic layer 120 may be disposed between protective layer 110 and isolating layer 130. Alternatively in at least some exemplary embodiments, protective layer 110, viscoelastic layer 120, and isolating layer 130 may be attached to each other in any desired order.

Protective layer 110 may be any suitable layer for providing a protective film for membrane 105. Protective layer 110 may substantially protect membrane 105 from scratches, scrapes, dents, deterioration, abrasions, and/or any other potential damage to which membrane 105 may be subjected (e.g., from impact damage, weather, and/or other external forces or physical contact). Protective layer 110 may also serve as a thermal isolation layer to provide protection for membrane 105 against temperature influence. Protective layer 110 may also serve as a vapor or moisture barrier. For example, protective layer 110 may protect against mechanical damage, temperature influence, and/or moisture. Protective layer 110 may reflect ultraviolet radiation (e.g., sunlight) and/or other temperature-increasing effects away from membrane 105. Protective layer 110 may be a metallic layer (e.g., a metallized film). Protective layer 110 may be a metallic foil. In at least some exemplary embodiments, protective layer 110 may be aluminum foil (e.g., aluminium foil), stainless steel foil, titanium foil, nickel foil, and/or any other suitable foil for protecting against mechanical damage and/or temperature influence. Protective layer 110 may be formed from any suitable material for protecting against mechanical damage and/or temperature influence such as, for example, metal (e.g., foil), plastic (e.g., flexible plastic), fabric (e.g., flexible fabric), polymer material, and/or any other suitable material. Protective layer 110 may have any suitable thickness such as, for example, up to about 0.001 inches (e.g., about 1 mil), or up to about 0.1 inches (e.g., about 10 mils) or more (e.g., up to about 0.1 inches or 100 mils). For example, protective layer 110 may have a thickness of between about 0.1 mils and about 1 mil, between about 0.5 mils and about 1 mil, or between about 0.6 mils and about 0.95 mils. Also for example, protective layer 110 may have a thickness of between about 0.01 millimeters and about 0.2 millimeters

Viscoelastic layer 120 may be any suitable layer having viscous and/or elastic characteristics under deformation (e.g., when deforming). For example, viscoelastic layer 120 may exhibit both viscous and elastic characteristics or behavior when deforming. Viscoelastic layer 120 may be formed from any suitable viscoelastic material or materials. Viscoelastic layer 120 may be formed from a polymer material. Viscoelastic layer 120 may be formed from rubber, synthetic rubber, and/or elastomeric material. In at least some exemplary embodiments, viscoelastic layer 120 may be formed from a butyl material (e.g., butyl rubber). Viscoelastic layer 120 may be formed from caoutchouc (e.g., modified caoutchouc) or any other suitable rubber material. Viscoelastic layer 120 may have any suitable thickness such as, for example, up to about 1 inch, up to about 0.5 inches, up to about 0.3 inches, between about 0.1 inch and about 0.4 inches, and/or any other suitable thickness. Also for example, viscoelastic layer 120 may have a thickness of between about 0.5 millimeters and about 5 millimeters.

Isolating layer 130 may be any suitable layer for providing thermal isolation and/or a vapor or moisture barrier. Isolating layer 130 may be a thermal isolating layer having any suitable thermal isolating characteristics such as, for example, a coefficient of thermal conductivity λ at 20° C. of up to about 0.038, up to about 0.05, between about 0.030 and about 0.040, between about 0.033 and about 0.043, or between about 0.036 and about 0.040 (e.g., about 0.038). For example, isolating layer 130 may have a coefficient of thermal conductivity λ at 20° C. of between about 0.038 and about 0.05. Isolating layer 130 may thereby provide membrane 105 with suitable (e.g., good or favorable) thermal insulating properties. Isolating layer 130 may be formed from any suitable material for providing suitable thermal insulating properties such as, for example, polymers such as foam, thermoplastic material, and/or thermoset material. Isolating layer 130 may be formed from foam material. Isolating layer 130 may include caoutchouc, rubber, polyethylene, and/or polyurethane material. For example, isolating layer 130 may be formed from foamed polymer material (e.g., polymeric foam) including caoutchouc, rubber, polyethylene, and/or polyurethane material. In at least some exemplary embodiments, isolating layer 130 may be formed from foam rubber (e.g., foamed caoutchouc). Isolating layer 130 may be formed from any suitable foam material for example including rubber, synthetic rubber, and/or elastomeric material. For example, isolating layer 130 may be a foamed synthetic caoutchouc layer. Isolating layer 130 may have any suitable thickness such as, for example, up to about 1 inch, up to about 0.5 inches, up to about 0.3 inches, between about 0.1 inch and about 0.4 inches, and/or any other suitable thickness. Also for example, isolating layer 130 may have a thickness of between about 2 millimeters and about 30 millimeters.

Attachment layer 140 may be any suitable layer for attaching membrane 105 to a surface (e.g., surface 160) of an element to which membrane 105 may be attached for sound control. Attachment layer 140 may be any suitable layer for attaching membrane 105 to surface 160 that may be smooth, irregular, rough, and/or having any other suitable characteristics for attachment. Attachment layer 140 may be an adhesive layer or any other desired layer for attachment (e.g., magnetic, hook or loop, and/or any other suitable attachment layer). In at least some exemplary embodiments, isolating layer 130 may be formed from any suitable adhesive material such as glue, hot-melt, pressure-sensitive adhesive, rubber, resin, acetate, epoxy, polyurethane, and/or any other suitable adhesive material. Attachment layer 140 may be an adhesive layer for fixedly or removably attaching membrane 105 to surface 160. Attachment layer 140 may have any suitable thickness such as, for example, up to about 0.1 inches, up to about 0.01 inches, or between about 2 mils and about 6 mils. Also for example, attachment layer 140 may have a thickness of between about 0.01 millimeters and about 1 millimeter.

As illustrated in FIG. 3, membrane 105 may also include a cover layer 150. Before second surface 140b of attachment layer 140 is attached to surface 160 of an element to which membrane 105 may be attached for sound control, cover layer 150 may be removably attached to and may cover second surface 140b. For example, a first surface 150a of cover surface 150 may be attached to and may cover second surface 140b of attachment layer 140 that may be an adhesive surface. For example, when membrane 105 is stored and/or transported, cover layer 150 may be attached to attachment layer 140 to substantially prevent attachment layer 140 from being unintentionally attached (e.g., adhered) to a surface, an element, and/or another portion of membrane 105. A second surface 150b of cover layer 150 may provide a non-adhesive surface or cover to substantially prevent second surface 140b of attachment layer 140 from being unintentionally attached or adhered. For example, before membrane 105 is to be attached to an element for sound control, cover layer 150 may be removed from attachment layer 140. In at least some exemplary embodiments, cover layer 150 may be removably detached and reattached to attachment layer 140. Cover layer 150 may have any suitable thickness such as, for example, a thickness less than, similar to, or greater than a thickness of attachment layer 140 for example as described above. Cover layer 150 may be formed from any suitable material for removably attaching to and covering attachment layer 140 such as, for example, paper (e.g., paper coated with silicone or similar material), vinyl, polyethylene material (e.g., polyethylene fiber material), and/or any other suitable material.

In at least some exemplary embodiments, membrane 105 may include: protective layer 110, viscoelastic layer 120, and isolating layer 130; protective layer 110, viscoelastic layer 120, isolating layer 130, and attachment layer 140; or protective layer 110, viscoelastic layer 120, isolating layer 130, attachment layer 140, and cover layer 150. Membrane 105 may be a flexible membrane (e.g., a very flexible membrane). For example, each of the protective layer 110, viscoelastic layer 120, isolating layer 130, attachment layer 140, and/or cover layer 150 may be a flexible layer so that an entire membrane 105 may be flexible. Membrane 105 may be a viscoelastic membrane coated by metallic foil. Membrane 105 may be a noise reduction or soundproofing membrane. Membrane 105 may have relatively high damping properties based on the exemplary disclosed layers and may eliminate structural and/or airborne noise. Membrane 105 may have sound insulation of between about 20 dB and about 40 dB, up to about 35 dB, up to about 26 dB, or between about 24 dB and about 28 dB (e.g., about 26 dB). For example, membrane 105 may have sound insulation of between about 10 dB and about 35 dB. Membrane 105 may provide a vapor or moisture barrier based on the exemplary disclosed layers. One or more of the exemplary disclosed layers of membrane 105 (e.g., viscoelastic layer 120 and/or isolating layer 130) may have a closed cellular structure and/or be formed from material that may provide membrane 105 with suitable (e.g., good or increased) thermal insulating properties. Membrane 105 (e.g., as a whole) may have thermal isolating characteristics similar to as described above regarding isolating layer 130. Membrane 105 may have a moisture resistance of up to about 100% (e.g., of substantially about 100% or substantially complete moisture resistance). Membrane 105 may be used at temperatures as low as about −58° F. and as high as about 212° F. For example, membrane 105 may be used at temperatures between about −58° F. and about 212° F. (e.g., between about −58° F. and about −25° F., between about −55° F. and about −35° F., between about −58° F. and about −40° F., between about 150° F. and about 212° F., between about 175° F. and about 212° F., between about 190° F. and about 212° F., or between about 200° F. and about 210° F.).

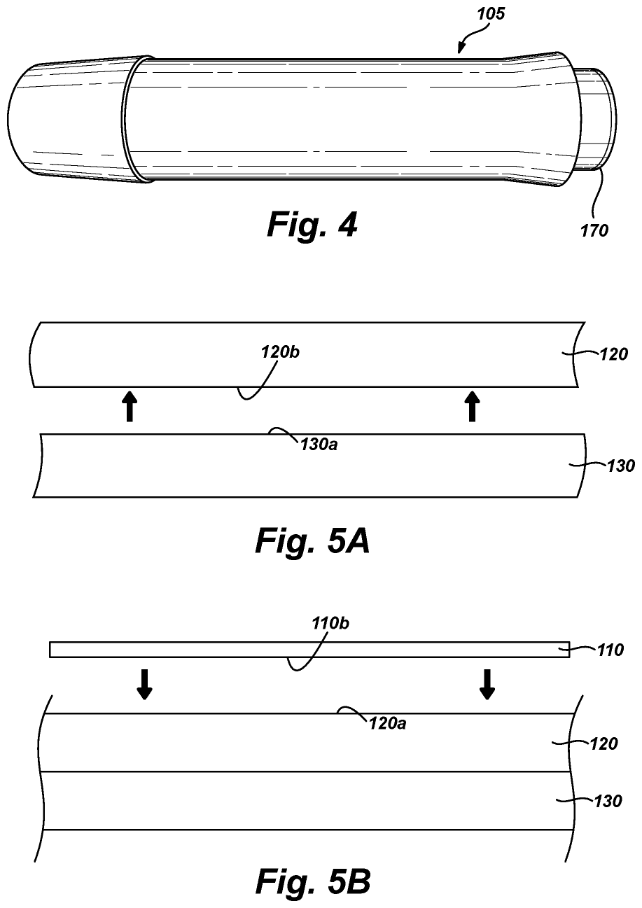

In at least some exemplary embodiments and as illustrated in FIG. 4, membrane 105 may be configured as an elongated membrane (e.g., a strip) that may be wound about a member 170. Member 170 may be any suitable member for receiving, storing, and/or transporting membrane 105 such as, for example, a tube, a core, or a spool. Member 170 may be a hollow or a solid member. Member 170 may be formed from any suitable structural material for supporting rolled or wound membrane 105 such as, for example, plastic, metal, wood, cardboard, composite material, or any other suitable structural material. Membrane 105 may for example be an elongated sheet or roll having any suitable length and width (e.g., about 200″×20″ or any other desired dimensions). Membrane 105 may have any suitable area (e.g., surface area) such as, for example, between about 20 ft² and 30 ft² or any other suitable surface area. Membrane 105 may have any suitable surface density such as, for example, between about 0.51 lbs/ft² and about 2 lbs/ft² (e.g., about 1 lb/ft²). Membrane 105 may have any suitable thickness such as, for example, between about 0.1″ and about 1″, between about 0.25″ and about 0.75″, or between about 0.4″ and about 0.6″ (e.g., about 0.5″). A roll of membrane 105 for example as illustrated in FIG. 4 may have any suitable weight such as, for example, between about 20 lbs and about 30 lbs or any other suitable weight. A roll of membrane 105 for example as illustrated in FIG. 4 may have any suitable volume such as, for example, between about 1 ft³ and about 2 ft³ or any other suitable volume (e.g., dimensions of about 20″×about 11″×about 11″ or any other suitable dimensions).

The exemplary disclosed system, apparatus, and method may be used in any suitable application for noise control. For example, the exemplary disclosed system, apparatus, and method may be used in any suitable application for noise control within buildings, vehicles, and/or any other suitable location. The exemplary disclosed system, apparatus, and method may be used in any suitable application for soundproofing building and/or structural elements. The exemplary disclosed system, apparatus, and method may be used in any suitable application for applying acoustic material to elements of any suitable structure, vehicle, and/or other suitable element or location.

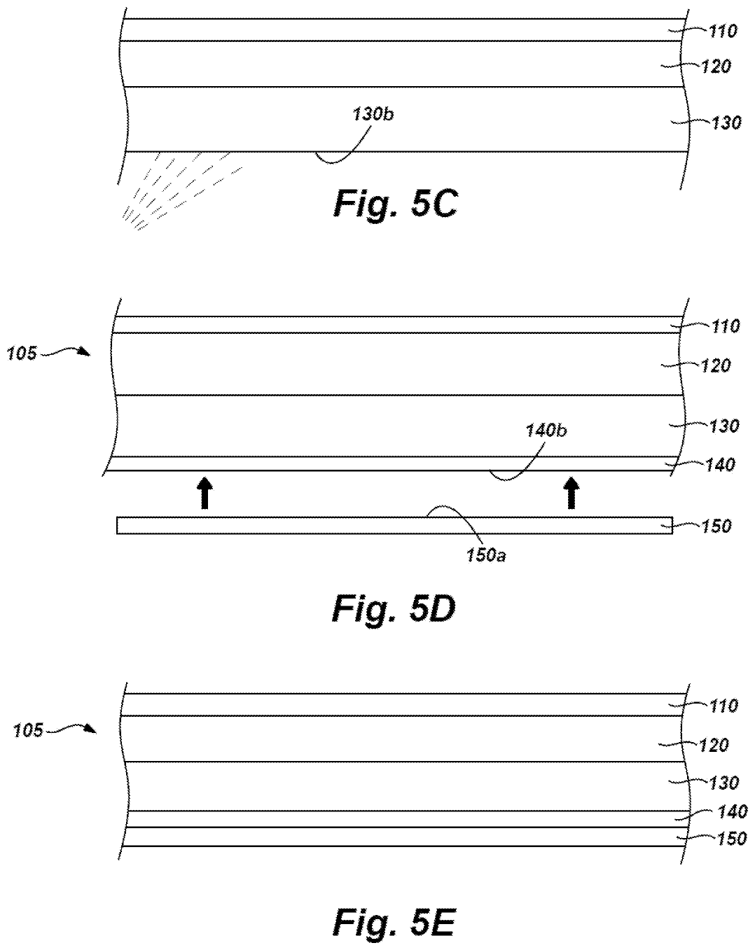

FIGS. 5A through 5E illustrate an exemplary process for making membrane 105. Viscoelastic layer 120 may be heated by any suitable technique such as, for example, via a heater (e.g., based on viscoelastic layer 120 being disposed on a heated surface and/or exposed directly or indirectly to a heat source). When viscoelastic layer 120 is still heated and as illustrated in FIG. 5A, isolating layer 130 may be put into contact with viscoelastic layer 120 so that first surface 130a of isolating layer 130 contacts heated second surface 120b of heated viscoelastic layer 120, which may attach isolating layer 130 to viscoelastic layer 120 (e.g., the layers may remain attached as viscoelastic layer 120 cools). Further, either when viscoelastic layer 120 is still heated or when viscoelastic layer 120 is heated again (and as illustrated in FIG. 5B), protective layer 110 may be put into contact with viscoelastic layer 120 so that second surface 110b of protective layer 110 contacts heated first surface 120a of heated viscoelastic layer 120, which may attach protective layer 110 to viscoelastic layer 120 (e.g., the layers may remain attached as viscoelastic layer 120 cools).

As illustrated in FIG. 5C, the exemplary disclosed material for forming attachment layer 140 for example as described above may be applied to second surface 130b of isolating layer 130 via any suitable technique such as, for example, via spraying, brushing, curtain coating, and/or any other suitable technique. In at least some exemplary embodiments, the material for forming attachment layer 140 may be heated when it is applied. As illustrated in FIGS. 5D and 5E, cover layer 150 may be removably attached to attachment layer 140 based on removably attaching first surface 150a of cover layer 150 to second surface 140b of attachment layer 140.

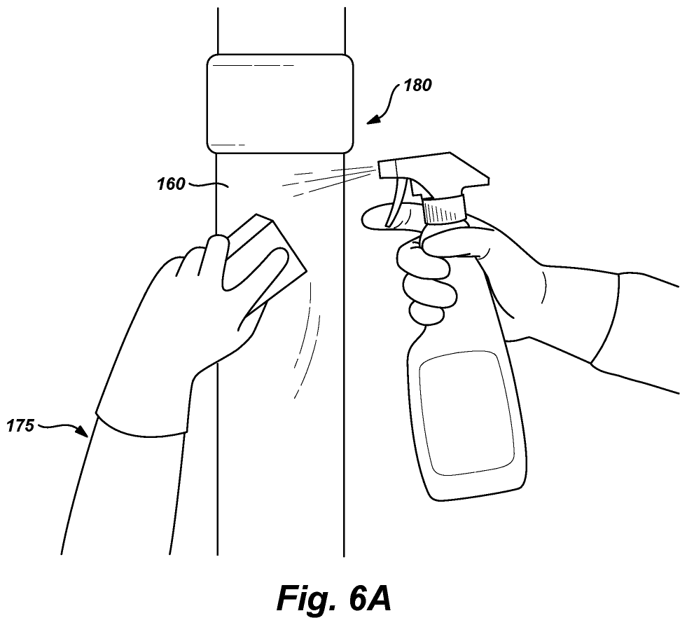

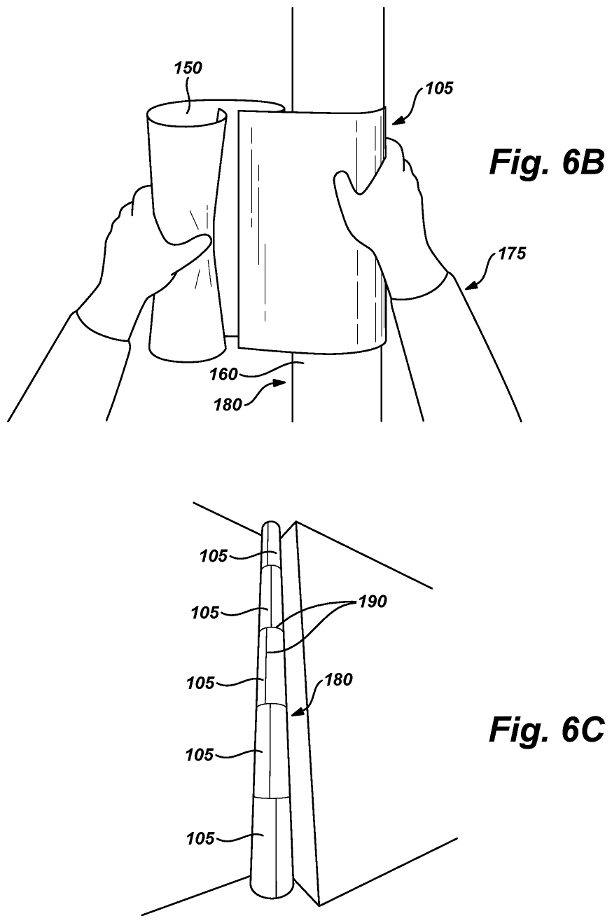

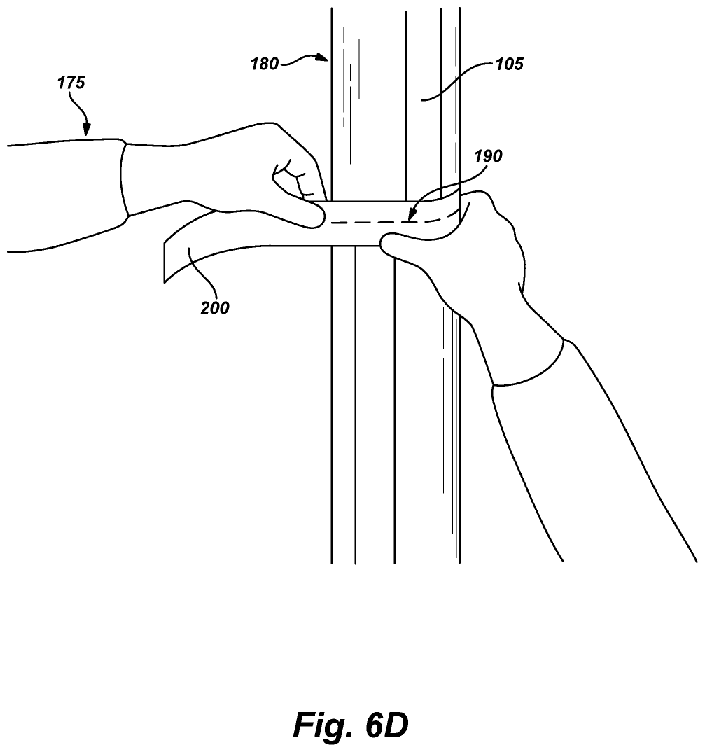

FIGS. 6A through 6D illustrate an exemplary process for using membrane 105. As illustrated in FIG. 6A, a user 175 may prepare surface 160 of an element 180 (e.g., a pipe) to which membrane 105 may be attached for sound control. For example, user 175 may wash, degrease, dry, and/or perform any other suitable preparation steps to prepare surface 160. As illustrated in FIG. 6B, user 175 may remove cover layer 150 from attachment layer 140 (e.g., from second surface 140b of attachment layer 140). User 175 may then attach membrane 105 to element 180 by adhering adhesive second surface 140b to surface 160. User 175 may cut membrane 105 at any desired length or interval to provide pieces of membrane 105 that fit element 180 (e.g., corresponding to a perimeter or other suitable dimension of element 180). As illustrated in FIG. 6C, some or substantially all of element 180 may be covered based on attaching one or more pieces of membrane 105 to element 180. Membrane 105 may be smoothed (e.g., smoothed out) as it is attached to element 180 based on adhering second surface 140b to prepared surface 160 (e.g., including smoothing out membrane 105 as it is attached). As illustrated in FIGS. 6C and 6D, seams 190 (e.g., horizontal and/or longitudinal seams) may be covered with covering 200. For example, seams 190 may be covered by user 175 with covering 200 that may be sealing tape (e.g., metallic sealing tape such as aluminum sealing tape).

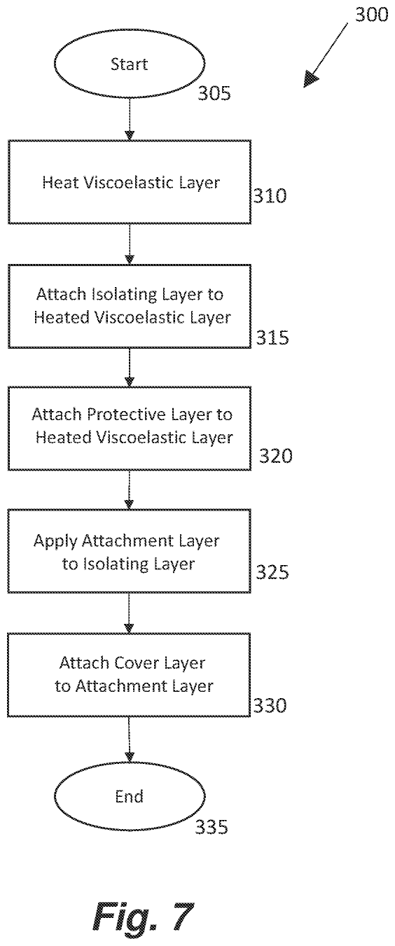

FIG. 7 illustrates an exemplary process of making the exemplary disclosed membrane. Process 300 begins at step 305. At step 310, viscoelastic layer 120 may be heated for example as described above (e.g., regarding FIGS. 5A and 5B). At step 315, isolating layer 130 may be attached to viscoelastic layer 120 for example as described above regarding FIG. 5A. At step 320, protective layer 110 may be attached to viscoelastic layer 120 for example as described above regarding FIG. 5B. At step 325, attachment layer 140 may be applied to isolating layer 130 for example as described above regarding FIG. 5C. At step 330, cover layer 150 may be attached to attachment layer 140 for example as described above regarding FIGS. 5D and 5E. Process 300 ends at step 335.

In at least some exemplary embodiments, the exemplary disclosed sound control membrane may include a viscoelastic layer (e.g., viscoelastic layer 120), a protective layer (e.g., protective layer 110) attached to the viscoelastic layer, and a thermal isolating layer (e.g., isolating layer 130) attached to the viscoelastic layer. The viscoelastic layer may be disposed between the protective layer and the thermal isolating layer. The viscoelastic layer may be formed from a rubber material. The viscoelastic layer may be formed from butyl rubber. The viscoelastic layer may be formed from a caoutchouc material. The thermal isolating layer may be formed from foam material. The thermal isolating layer may be formed from foamed polymer material. The thermal isolating layer may be formed from foamed caoutchouc. The protective layer may be formed from metallic foil. Each of the viscoelastic layer, the protective layer, and the thermal isolating layer may be a flexible layer. The exemplary disclosed sound control membrane may also include an adhesive layer attached to the thermal isolating layer. The thermal isolating layer may have a coefficient of thermal conductivity λ at 20° C. of between 0.038 and 0.05. The sound control membrane may have sound insulation of between 10 dB and 35 dB. The sound control membrane may have a thickness of between 0.25″ and 0.75″ and may be impermeable to moisture.

In at least some exemplary embodiments, the exemplary disclosed sound control method may include providing a sound control membrane including a viscoelastic layer (e.g., viscoelastic layer 120), a protective layer (e.g., protective layer 110) attached to the viscoelastic layer, a thermal isolating layer (e.g., isolating layer 130) attached to the viscoelastic layer, and an attachment layer (e.g., attachment layer 140) attached to the thermal isolating layer. The viscoelastic layer may be disposed between the protective layer and the thermal isolating layer. The exemplary disclosed sound control method may also include attaching the sound control membrane to an element by attaching the attachment layer to a surface of the element. The element may be soundproofed to between 10 dB and 35 dB based on the sound control membrane being attached to the element. The sound control membrane may be exposed to temperatures as low as −58° F. and as high as 212° F. The exemplary disclosed sound control method may further include unrolling the sound control membrane from a member and removing a non-adhesive cover layer from an adhesive surface of the attachment layer before attaching the sound control membrane to the element.

In at least some exemplary embodiments, the exemplary disclosed sound control apparatus may include a sound control membrane including a viscoelastic layer (e.g., viscoelastic layer 120) formed from a rubber material, a protective layer (e.g., protective layer 110) attached to the viscoelastic layer, a thermal isolating layer (e.g., isolating layer 130) attached to the viscoelastic layer, and an adhesive layer attached to the thermal isolating layer. The viscoelastic layer may be disposed between the protective layer and the thermal isolating layer. The exemplary disclosed sound control apparatus may also include a member around which the sound control membrane is wrapped. The viscoelastic layer may be formed from butyl rubber. The exemplary disclosed sound control apparatus may further include a cover layer that may be removably attached to an adhesive surface of the adhesive layer when the sound control membrane is wrapped around the member.

In at least some exemplary embodiments, the exemplary disclosed system, apparatus, and method may provide an efficient and effective system for noise control of a structure (e.g., building), vehicle, and/or any other desired location. For example, the exemplary disclosed system, apparatus, and method may provide a noise control technique that may involve non-toxic materials. Also for example, the exemplary disclosed system, apparatus, and method may provide a versatile noise control technique for applying acoustic materials at a variety of locations having differing shapes and configurations. Further for example, the exemplary disclosed system, apparatus, and method may involve substantially no volatile substances, may be fire resistant (e.g., may not be combustible), and/or may not emit unpleasant odors when used. Additionally for example, the exemplary disclosed system, apparatus, and method may be used in areas of relatively high humidity and/or temperature variation effectively with little or substantially no deterioration.

It will be apparent to those skilled in the art that various modifications and variations can be made to the exemplary disclosed system, apparatus, and method. Other embodiments will be apparent to those skilled in the art from consideration of the specification and practice of the exemplary disclosed apparatus, system, and method. It is intended that the specification and examples be considered as exemplary, with a true scope being indicated by the following claims.

What is claimed is:

1. A sound control membrane, comprising:
a viscoelastic layer;
a protective layer attached to the viscoelastic layer; and
a thermal isolating layer attached to the viscoelastic layer;
wherein the viscoelastic layer is disposed between the protective layer and the thermal isolating layer.

2. The sound control membrane of claim 1, wherein the viscoelastic layer is formed from a rubber material.

3. The sound control membrane of claim 1, wherein the viscoelastic layer is formed from butyl rubber.

4. The sound control membrane of claim 1, wherein the viscoelastic layer is formed from a caoutchouc material.

5. The sound control membrane of claim 1, wherein the thermal isolating layer is formed from foam material.

6. The sound control membrane of claim 1, wherein the thermal isolating layer is formed from foamed polymer material.

7. The sound control membrane of claim 1, wherein the thermal isolating layer is formed from foamed caoutchouc.

8. The sound control membrane of claim 1, wherein the protective layer is formed from metallic foil.

9. The sound control membrane of claim 1, wherein each of the viscoelastic layer, the protective layer, and the thermal isolating layer is a flexible layer.

10. The sound control membrane of claim 1, further comprising an adhesive layer attached to the thermal isolating layer.

11. The sound control membrane of claim 1, wherein the thermal isolating layer has a coefficient of thermal conductivity λ at 20° C. of between 0.038 and 0.05.

12. The sound control membrane of claim 1, wherein the sound control membrane has sound insulation of between 10 dB and 35 dB.

13. The sound control membrane of claim 1, wherein the sound control membrane has a thickness of between 0.25″ and 0.75″ and is impermeable to moisture.

14. A sound control method, comprising:
providing a sound control membrane including
a viscoelastic layer,
a protective layer attached to the viscoelastic layer,
a thermal isolating layer attached to the viscoelastic layer, and
an attachment layer attached to the thermal isolating layer,
wherein the viscoelastic layer is disposed between the protective layer and the thermal isolating layer; and
attaching the sound control membrane to an element by attaching the attachment layer to a surface of the element.

15. The method of claim 14, wherein the element is soundproofed to between 10 dB and 35 dB based on the sound control membrane being attached to the element.

16. The method of claim 14, wherein the sound control membrane is exposed to temperatures as low as −58° F. and as high as 212° F.

17. The method of claim 14, further comprising unrolling the sound control membrane from a member and removing a non-adhesive cover layer from an adhesive surface of the attachment layer before attaching the sound control membrane to the element.

18. A sound control apparatus, comprising:
a sound control membrane including
a viscoelastic layer formed from a rubber material,
a protective layer attached to the viscoelastic layer,
a thermal isolating layer attached to the viscoelastic layer, and
an adhesive layer attached to the thermal isolating layer,
wherein the viscoelastic layer is disposed between the protective layer and the thermal isolating layer; and
a member around which the sound control membrane is wrapped.

19. The sound control apparatus of claim 18, wherein the viscoelastic layer is formed from butyl rubber.

20. The sound control apparatus of claim 18, further comprising a cover layer that is removably attached to an adhesive surface of the adhesive layer when the sound control membrane is wrapped around the member.
